(19) United States
(12) Patent Application Publication
(10) Pub. No.: US 2026/0141820 A1
(43) Pub. Date: May 21, 2026

(54) INTERACTIVE LEARNING MATERIAL GENERATION METHOD AND RELATED COMPUTER SYSTEM

(71) Applicant: ViewSonic International Corporation, New Taipei City (TW)

(72) Inventors: Hsin-Yu Lin, New Taipei City (TW); Kevin-Kuo Chu, New Taipei City (TW); Yu-Ming Lu, New Taipei City (TW)

(73) Assignee: ViewSonic International Corporation, New Taipei City (TW)

(21) Appl. No.: 19/070,546

(22) Filed: Mar. 5, 2025

(30) Foreign Application Priority Data
Nov. 21, 2024 (TW) 113144856

(51) Int. Cl. G09B 7/02

(52) U.S. Cl. CPC G09B 7/02

(57) ABSTRACT

An interactive learning material generation method, for a computer system, includes recognizing data of a resource database with a few-shot learning (FSL) method to determine at least one learning topic; comparing a specified topic with the at least one learning topic to determine a comparison result; collecting learning data associated with the comparison result based on the comparison result; and adjusting a difficulty level of the learning content within the learning data according to a user's learning level.

### BACKGROUND OF THE INVENTION

### 1. Field of the Invention

The present invention relates to an interactive learning material generation method and a related computer system, more particularly, to an interactive learning material generation method and a related computer system capable of provide interactive and up-to-date learning materials.

### 2. Description of the Prior Art

Existing learning material content is typically developed by government agencies, major publishers, or other content-creating businesses, making it difficult to update frequently and on real-time. In this situation, learners or readers may lose interest in studying outdated learning contents or learning materials. On the other hand, while existing online resources can provide a variety of real-time materials, these resources are scattered across different platforms, making it difficult for learners or readers to efficiently and quickly filter the needed learning content.

Therefore, improvements are necessary in the approach to obtaining learning materials.

### SUMMARY OF THE INVENTION

In light of this, the present invention provides an interactive learning material generation method and a related computer system to provide the interactive and up-to-date learning materials.

An embodiment of the present invention discloses an interactive learning material generation method, for a computer system, comprises recognizing data of a resource database with a few-shot learning (FSL) method to determine at least one learning topic; comparing a specified topic with at least one learning topic to determine a comparison result; collecting learning data associated with the comparison result based on the comparison result; and adjusting a difficulty level of the learning content within the learning data according to a user's learning level.

Another embodiment of the present invention discloses a computer system, comprises a database, for data storage; and a processing unit, configured to execute an interactive learning material generation method, wherein the interactive learning material generation method includes recognizing data from a resource database using a few-shot learning (FSL) method to determine at least a learning topic; comparing a specified topic with at least one learning topic to determine a comparison result; collecting learning data associated with the comparison result according to the comparison result; and adjusting the difficulty level of the learning content related to the learning data according to a user's learning level.

These and other objectives of the present invention will no doubt become obvious to those of ordinary skills in the art after reading the following detailed description of the preferred embodiment that is illustrated in the various figures and drawings.

### BRIEF DESCRIPTION OF THE DRAWINGS

FIG. 1 is a schematic diagram of a computer system according to an embodiment of the present invention.

FIG. 2 is a schematic diagram of an interactive learning material generation method according to an embodiment of the present invention.

FIG. 3 is a schematic diagram of an interactive learning method according to an embodiment of the present invention.

FIG. 4 is a schematic diagram of a usage scenario according to an embodiment of the present invention.

### DETAILED DESCRIPTION

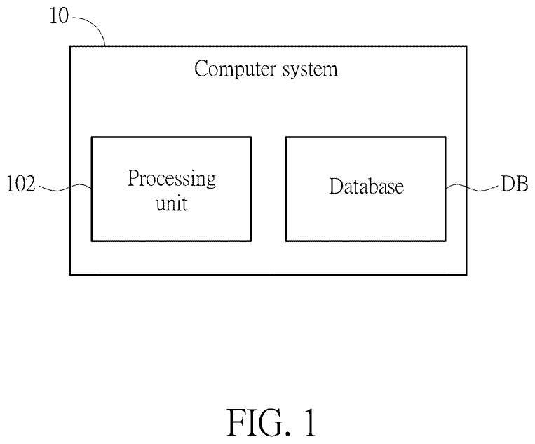

Please refer to FIG. 1, which is a schematic diagram of a computer system 10 according to an embodiment of the present invention. The computer system 10 includes a database DB and a processing unit 102, the computer system 10 may include an artificial intelligence (AI) Chatbot, the database DB is used to stores the data of the computer system 10, and the processing unit 102 is used to executes an interactive learning material generation method.

The computer system 10 of the present invention's embodiment can be used in an online learning classroom to interact with the users remotely and provide learning materials, wherein each user can be a student, a teacher, a learner or a reader. Specifically, the interactive learning material of the computer system 10 can be generated based on the resources on the Internet and provide it to users. Since users may have simple question-and-answer conversations with the Chatbot embedded in the computer system 10 online, the Chatbot can collect the users'responses as a basis for analysis, such that the computer system 10 may determine a learning status or a learning level of the users.

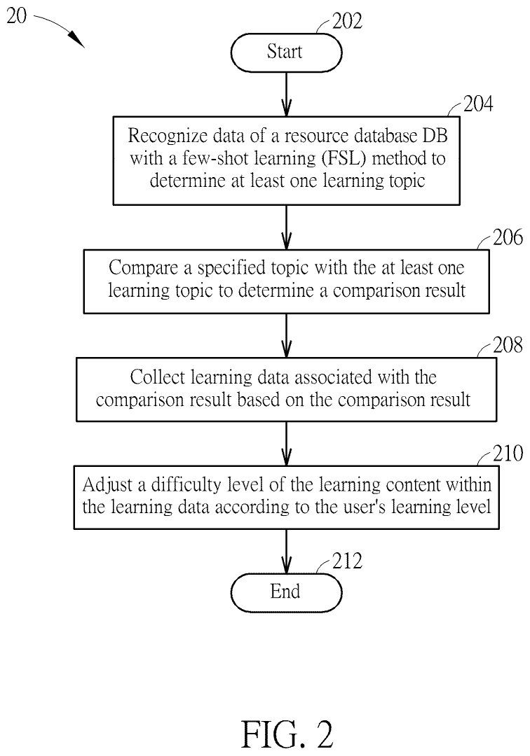

Please refer to FIG. 2, which is a schematic diagram of an interactive learning material generation method 20 according to an embodiment of the present invention. The interactive learning material generation method 20 includes the following steps:
Step 202: Start;
Step 204: Recognize data of a resource database DB with a few-shot learning (FSL) method to determine at least one learning topic;
Step 206: Compare a specified topic with the at least one learning topic to determine a comparison result;
Step 208: Collect learning data associated with the comparison result based on the comparison result;
Step 210: Adjust a difficulty level of the learning content within the learning data according to the user's learning level;
Step 212: End.

Based on the interactive learning material generation method 20, the computer system 10 may generate the interactive learning material according to resources on the Internet. In step 204, the computer system 10 recognizes the data of the resource database(DB) using few-shot learning method to determine at least one learning topic, wherein the resource database(DB) includes textbooks, quizzes or related documents conforming an education standards. In this way, the computer system 10 may recognize different topics of the resource database(DB), e.g., biology, medical, history, using a few-shot learning method based on the data in the resource database(DB).

After the user, e.g., a student or a teacher, determines a specified topic, in step 206, the computer system 10 compares the specified topic determined by the user to the learning topic of the resource database(DB), so as to determine the comparison result. That is, in step 206, the computer system 10 is configured to select the specified topic conforming to that determined by the user from the resource database(DB) and then go to step 208 based on the specified topic.

In step 208, the computer system 10 is configured to collect the learning data corresponding to the specified topic according to the comparison result of step 206, wherein the learning data may include at least one video, article, image or broadcast, etc. For example, the specified topic determined by the user in step 206 is history; in step 208, the computer system 10 searches for reliable websites content based on history, e.g., Khan Academy or British Broadcasting Corporation (BBC). The list of reliable websites may be determined by teachers or educational institutions.

In step 210, the difficulty level of learning content related to the learning data may be adjusted based on the user's learning level. The computer system 10 can first determine the student's learning level. For example, the computer system 10 can check whether any participation records and corresponding learning levels stored in the resource database(DB), if such records exist, the computer system 10 determines the difficulty level of the learning content according to the student's learning level stored in the resource database(DB); if no records are available, the computer system 10 analyzes the student's learning level according to an analysis of a conversation between the Chatbot and the student, and then adjusts the difficulty level of the learning content accordingly.

In an embodiment, the Chatbot may ask the student historical questions related to the learning topic, and the Chatbot can evaluate the student's learning level based on their responses during the answering process.

Therefore, based on the interactive learning material generation method 20, the computer system 10 may determine the learning content of the learning data with the few-shot learning(FSL) method, wherein the learning content includes multimedia data, and the multimedia data includes videos, articles, images or broadcasts, etc. Therefore, the student may learn the learning content generated by the interactive learning material generation method 20.

The learning material generated by the conventional AI may be divergent and lack of constructiveness. In an embodiment of the present invention, the learning content of the learning data are generated based on the educational principles according to the interactive learning material generation method 20 with few-shot learning method, such that the students may learn the materials in a more effective way.

In addition, after the students learn the learning content provided by the computer system 10, the computer system 10 may generate a leaning result report to the student based on the learning result of the student. Alternatively, the computer system 10 may generate a learning result report along with suggestions based on the learning result of the student and provide to the teacher. In another embodiment, the computer system 10 may adjust the difficulty level of the learning content in step 210 based on the learning results of the student to enhance the interactivity of the generation of the learning materials.

Therefore, the teacher may select the topic in different difficulties or select different specified topics according to the suggestions and the learning result report provided by the computer system 10.

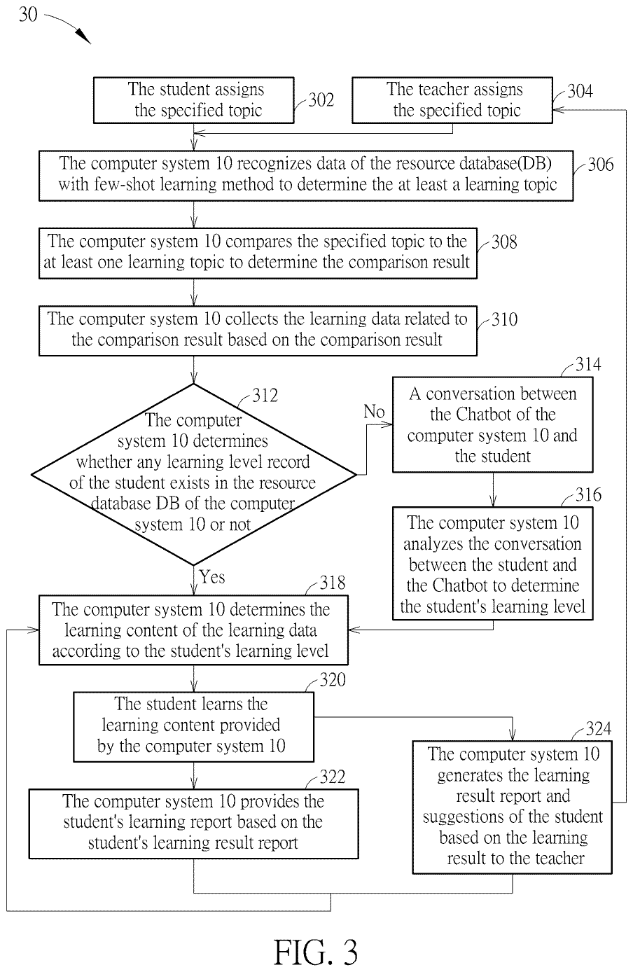

Please refer to FIG. 3, which is a schematic diagram of an interactive learning method 30 according to an embodiment of the present invention. The interactive learning method 30 may be applied to the computer system 10. The interactive learning method 30 illustrates the interaction process among the student, the teacher and the computer system 10, when the student and the teacher adopt the interactive learning material generation method 20. The interactive learning method 30 includes the following steps:
Step 302: The student assigns the specified topic;
Step 304: The teacher assigns the specified topic;
Step 306: The computer system 10 recognizes data of the resource database(DB) with few-shot learning method to determine the at least a learning topic;
Step 308: The computer system 10 compares the specified topic to the at least one learning topic to determine the comparison result;
Step 310: The computer system 10 collects the learning data related to the comparison result based on the comparison result;
Step 312: The computer system 10 determines whether any learning level record of the student exists in the resource database DB of the computer system 10 or not, if such records exist, go to step 318, if no records are available, go to step 314;
Step 314: A conversation between the Chatbot of the computer system 10 and the student;
Step 316: The computer system 10 analyzes the conversation between the student and the Chatbot to determine the student's learning level;
Step 318: The computer system 10 determines the learning content of the learning data according to the student's learning level;
Step 320: The student learns the learning content provided by the computer system 10;
Step 322: The computer system 10 provides the student's learning report based on the student's learning result report;
Step 324: The computer system 10 generates the learning result report and suggestions of the student based on the learning result to the teacher.

The operation of the interactive learning method 30 may be referred to the above mentioned embodiments of the computer system 10 and the interactive learning material generation method 20, and is not narrated herein for brevity.

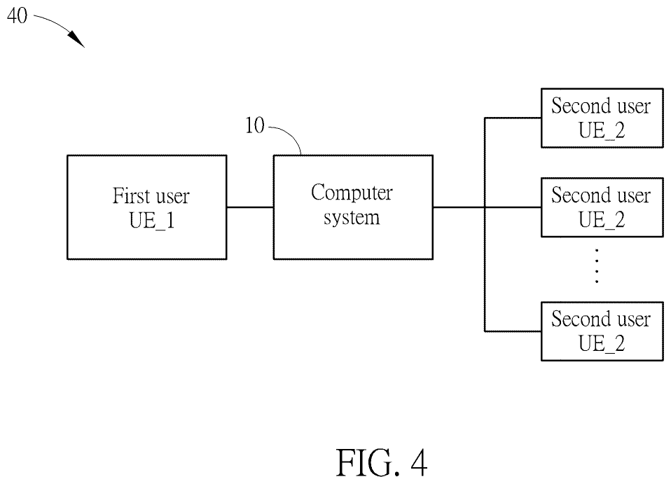

Please refer to FIG. 4, which is a schematic diagram of a usage scenario 40 according to an embodiment of the present invention. The usage scenario 40 includes the computer system 10, a first user UE_1 and a plurality of second users UE_2, wherein the first user UE_1 may be a teacher or a lecturer, the second user UE_2 may be a student or an audience. Notably, a number of the first user UE_1 and the second users UE_2 are not limited to the embodiment of FIG. 4, other quantities of the first user UE_1 and the second user UE_2 are also applicable to the present invention.

In addition, the computer system 10 may further include a cloud server and a third party application programming interface (API), but not limited thereto.

Notably, the embodiments of the present invention illustrated above may be properly modified by people skilled in the art based on the requirements of users or related computer systems, and are not limited to the above examples, which are within the scope of the present invention.

In summary, the present invention provides an interactive learning material generation method and related computer system to generate learning materials with interactivity and conforming to the educational principles via AI techniques, so as to improve a learning result of students.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An interactive learning material generation method, for a
computer system, comprising:
recognizing data of a resource database with a few-shot learning (FSL) method to determine at least one learning topic;
comparing a specified topic with the at least one learning topic to determine a comparison result;
collecting learning data based on the comparison result; and
adjusting a difficulty level of the learning content within the learning data according to a user's learning level.

2. The interactive learning material generation method of claim 1, wherein the learning topic is determined by the user.

3. The interactive learning material generation method of claim 1, wherein data of the resource database includes education standard data.

4. The interactive learning material generation method of claim 1, further comprising:
determining the user's learning level according to a conversation between a Chatbot and the user; and
adjusting the difficulty level of the learning content based on the learning data according to the user's learning level.

5. The interactive learning material generation method of claim 1, wherein the learning content includes multimedia data, and the multimedia data includes at least one video, article, image or broadcast.

6. The interactive learning material generation method of claim 1, wherein the learning content of the learning data is determined according to the few-shot learning method.

7. The interactive learning material generation method of claim 1, further comprising:
generating a learning report according to a result of the learning content of the learning data learned by the user; and
adjusting the learning content of the learning data according to at least a suggestion of the learning report.

8. A computer system, comprising:
a database, for data storage; and
a processing unit, configured to execute an interactive learning material generation method, wherein the interactive learning material generation method including:
recognizing data of a resource database with a few-shot learning (FSL) method to determine at least a learning topic;
comparing a specified topic with the at least one learning topic to determine a comparison result;
collecting learning data based on the comparison result; and
adjusting a difficulty level of the learning content within the learning data according to a user's learning level.

9. The computer system of claim 8, wherein the learning topic is determined by the user.

10. The computer system of claim 8, wherein data of the resource database includes education standard data.

11. The computer system of claim 8, wherein the interactive learning material generation method further comprises:
determining the user's learning level according to a conversation between a Chatbot and the user; and
adjusting the difficulty level of the learning content based on the learning data according to the user's learning level.

12. The computer system of claim 8, wherein the learning content includes multimedia data, and the multimedia data includes at least one video, article, image or broadcast.

13. The computer system of claim 8, wherein the learning content of the learning data is determined according to the few-shot learning method.

14. The computer system of claim 8, wherein the interactive
learning material generation method further comprises:
generating a learning report according to a result of the learning content of the learning data learned by the user; and
adjusting the learning content of the learning data according to at least a suggestion of the learning report.
